(19) United States
(12) Patent Application Publication
(10) Pub. No.: US 2005/0147096 A1
(43) Pub. Date: Jul. 7, 2005

(54) Methods, systems, and computer program products for using multiprotocol label switching (MPLS) to allocate network resources according to traffic type

(76) Inventors: Thomas Arnold Anschutz, Conyers, GA (US); James William Rembert, Atlanta, GA (US)

Correspondence Address: MYERS BIGEL SIBLEY & SAJOVEC, P.A., P.O. BOX 37428, RALEIGH, NC, 27627, US

(21) Appl. No.: 10/747,574

(22) Filed: Dec. 29, 2003

(51) Int. Cl. H04L 12/28

(52) U.S. Cl. 370/392; 370/351

(57) ABSTRACT

A multiprotocol label switching (MPLS) network, is operated by defining a first label switched path (LSP) between a first label switched router (LSR) and a second label switched router (LSR) in the MPLS network. A second LSP is defined between the first LSR and the second LSR in the MPLS network. Basic service packet traffic is routed from the first LSR to the second LSR using the first LSP and enhanced service packet traffic is routed from the first LSR to the second LSR using the second LSP.

### FIELD OF THE INVENTION

The present invention relates to communication networks, and, more particularly, to multiprotocol label switching (MPLS) communication networks.

### BACKGROUND OF THE INVENTION

Multiprotocol label switching (MPLS) provides a technique for routing packet data based on a label field rather than a destination address. An MPLS network comprises a set of nodes, which are called label switched routers (LSRs), that switch/route packets based on a label that has been added to each packet. Labels are used to define a flow of packets between two nodes or, if packets are being broadcast in a multicast operation, between a source node and multiple destination nodes. A specific path through the LSRs called a label switched path (LSP) is defined for each distinct flow, which is called a forwarding equivalence class (FEC). At intervening nodes in an LSP, an LSR may route the packet based on the MPLS label value, remove the MPLS label (pop a label), and/or impose an additional label (push a label). The label may be removed at the node from the packet at a node that is just prior to the destination node in a particular LSP. This process is sometimes referred to as “penultimate hop popping.”

Referring now to FIG. 1, an exemplary MPLS label and Internet Protocol (IP) packet are illustrated. The MPLS label is a 32-bit header that includes a 20-bit label field, a 3-bit Exp field that is reserved for experimental use, a 1-bit S field that is set to one for the oldest entry in the stack and zero for all other entries, and an 8-bit time-to-live (TTL) field that may be used to encode a hop count or time-to-live value. An MPLS label may also be referred to as an MPLS shim header. As shown in FIG. 1, multiple MPLS labels or shim headers may be included in a single IP packet. The MPLS labels or shim headers are organized as a last-in, first-out stack and are processed based on the top MPLS label or shim header. As discussed above, an LSR may add an MPLS label or shim header to the stack (push operation) or remove an MPLS label or shim header from the stack (pop operation).

In IP networks, packets are typically treated in a “work conserving” method, which means that various traffic types can make elastic use of resources. Generally, it is desirable to be able to share common infrastructure among basic and enhanced services. An enhanced service is any telecommunications service that uses computer-based processing applications to provide the customer with value-added telecommunications services. Telecommunications service providers are allowed to share common network infrastructure among basic and enhanced services if “Part-X” accounting rules are followed. Part-X accounting does not allow for elastic use of resources, but instead requires pre-defined partitions among resources that are used to provide basic and enhanced services. Moreover, according to Part-X accounting rules, the pre-defined partitions must be defined in advance rather than in real-time as traffic is being processed.

### SUMMARY OF THE INVENTION

According to some embodiments of the present invention, a multiprotocol label switching (MPLS) network, is operated by defining a first label switched path (LSP) between a first label switched router (LSR) and a second label switched router (LSR) in the MPLS network. A second LSP is defined between the first LSR and the second LSR in the MPLS network. Basic service packet traffic is routed from the first LSR to the second LSR using the first LSP and enhanced service packet traffic is routed from the first LSR to the second LSR using the second LSP.

In other embodiments of the present invention, a basic resource capacity is defined between the first LSR and the second LSR and an enhanced service resource capacity is defined between the first LSR and the second LSR.

In still other embodiments of the present invention, basic service packet traffic is routed from the first LSR to the second LSR using the first LSP such that the basic service packet traffic does not exceed the basic service resource capacity. Enhanced service packet traffic is routed from the first LSR to the second LSR using the second LSP such that the enhanced service packet traffic does not exceed the enhanced service resource capacity.

In still other embodiments of the present invention, the basic resource capacity comprises a basic service bandwidth and the enhanced service resource capacity comprises an enhanced service bandwidth.

In still other embodiments of the present invention, basic service packet traffic is routed from the first LSR to the second LSR using the first LSP such that the basic service packet traffic does not exceed the basic service bandwidth. Enhanced service packet traffic is routed from the first LSR to the second LSR using the second LSP such that the enhanced service packet traffic does not exceed the enhanced service bandwidth.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional multiprotocol label switching (MPLS) label or shim header and internet protocol (IP) packet;

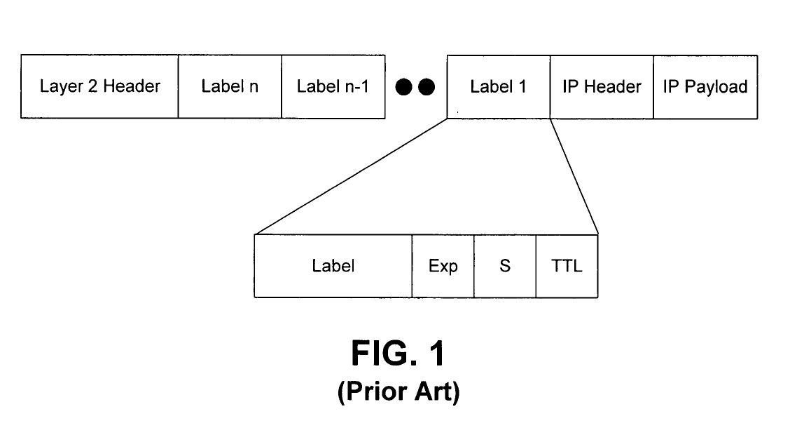

FIG. 2 is a block diagram that illustrates an MPLS network in accordance with some embodiments of the present invention; and

FIG. 3 is a flowchart that illustrates operations for using MPLS to allocate network resources according to traffic type in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

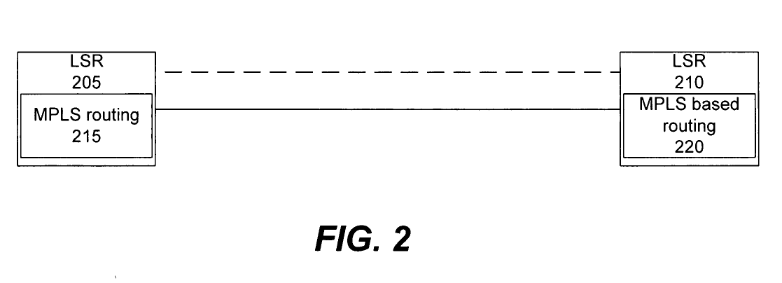

Referring now to FIG. 2, two nodes or label switch routers (LSRs) 205 and 210 in a multiprotocol label switching (MPLS) network, in accordance with some embodiments of the present invention, are illustrated. As shown in FIG. 2, LSRs 205 and 210 comprise MPLS routing modules 215 and 220, respectively, which may be configured to establish two label switched paths, which are denoted by the solid and dashed lines in FIG. 2, between the LSRs 205 and 210. As discussed above, telecommunications service providers are not allowed to share common network infrastructure among basic and enhanced services unless Part-X accounting rules are followed. To comply with Part-X accounting rules, a telecommunications service provider must establish pre-defined partitions among resources that are used to provide basic and enhanced services. As will be described hereafter, embodiments of the present invention may allow a telecommunications service provider to use its network resources to provide both basic and enhanced services while complying with Part-X accounting rules in a generally efficient manner.

Although FIG. 2 illustrates an exemplary MPLS network, it will be understood that the present invention is not limited to such configurations, but is intended to encompass any configuration capable of carrying out the operations described herein. It will be appreciated that, in accordance with some embodiments of the present invention, the functionality of the MPLS routing modules 215 and 220 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the MPLS routing modules 215 and 220 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

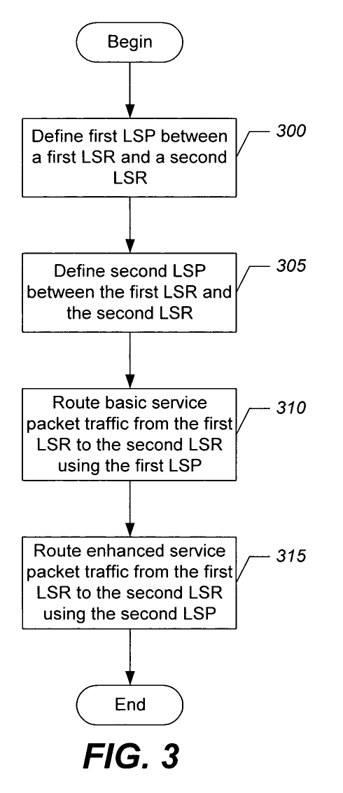

Operations for allocating network resources according to traffic type, in accordance with some embodiments of the present invention, will now be described with reference to FIGS. 3 and 2. Referring now to FIG. 3, operations begin at block 300 where a first LSP between, for example, LSRs 205 and 210 is defined. At block 305, a second LSP between LSRs 205 and 210 is defined. The MPLS routing module 215, for example, may route basic service packet traffic from LSR 205 to LSR 210 using the first LSP at block 310. The MPLS routing module 215 may route enhanced service packet traffic from LSR 205 to LSR 210 using the second LSP at block 310. Thus, the two LSPs connecting the LSRs 205 and 215 may represent a pre-defined resource partition in the MPLS network that a telecommunications service provider may use to comply with Part-X accounting rules.

For example, a telecommunications service provider may use traffic engineering to define a basic service resource capacity between LSR 205 and LSR 210 and an enhanced service resource capacity between LSR 205 and LSR 210. The MPLS routing module 215, for example, may then ensure that the basic service traffic that is routed on the first LSP between LSR 205 and LSR 210 does not exceed the pre-defined basic service resource capacity. Similarly, the MPLS routing module 215 may ensure that the enhanced service traffic that is routed on the second LSP between LSR 205 and LSR 210 does not exceed the pre-defined enhanced service resource capacity. A resource capacity may be, for example, a bandwidth or rate limit in accordance with some embodiments of the present invention. Other metrics may be used to evaluate resource capacity in accordance with other embodiments of the present invention.

Advantageously, allocating network resource capacity according to traffic type according to various embodiments of the present invention may allow a telecommunications service provider to map regulatory accounting rules to traffic engineering tools used to set up routing in an MPLS network, for example. Moreover, embodiments of the present invention may ensure that the accounting of the traffic carried by a network matches the actual capability of the network by associating the accounting rules with the network routing and resource capacity rules, e.g., bandwidth limits, rate limits, etc.

The flowchart of FIG. 3 illustrates the architecture, functionality, and operations of some embodiments of methods, systems, and computer program products for allocating network resource capacity according to traffic type. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

1. A method of operating a multiprotocol label switching (MPLS) network, comprising:
defining a first label switched path (LSP) between a first label switched router (LSR) and a second LSR in the MPLS network;
defining a second LSP between the first LSR and the second LSR in the MPLS network;
routing basic service packet traffic from the first LSR to the second LSR using the first LSP; and
routing enhanced service packet traffic from the first LSR to the second LSR using the second LSP.

2. The method of claim 1, further comprising:
defining a basic service resource capacity between the first LSR and the second LSR; and
defining an enhanced service resource capacity between the first LSR and the second LSR.

3. The method of claim 2, wherein routing basic service packet traffic from the first LSR to the second LSR using the first LSP comprises routing basic service packet traffic from the first LSR to the second LSR using the first LSP such that the basic service packet traffic does not exceed the basic service resource capacity; and wherein routing enhanced service packet traffic from the first LSR to the second LSR using the second LSP comprises routing enhanced service packet traffic from the first LSR to the second LSR using the second LSP such that the enhanced service packet traffic does not exceed the enhanced service resource capacity.

4. The method of claim 2, wherein the basic service resource capacity comprises a basic service bandwidth, and wherein the enhanced service resource capacity comprises an enhanced service bandwidth.

5. The method of claim 4, wherein routing basic service packet traffic from the first LSR to the second LSR using the first LSP comprises routing basic service packet traffic from the first LSR to the second LSR using the first LSP such that the basic service packet traffic does not exceed the basic service bandwidth; and wherein routing enhanced service packet traffic from the first LSR to the second LSR using the second LSP comprises routing enhanced service packet traffic from the first LSR to the second LSR using the second LSP such that the enhanced service packet traffic does not exceed the enhanced service bandwidth.

6. A system for operating a multiprotocol label switching (MPLS) network, comprising:
means for defining a first label switched path (LSP) between a first label switched router (LSR) and a second LSR in the MPLS network;
means for defining a second LSP between the first LSR and the second LSR in the MPLS network;
means for routing basic service packet traffic from the first LSR to the second LSR using the first LSP; and
means for routing enhanced service packet traffic from the first LSR to the second LSR using the second LSP.

7. The system of claim 6, further comprising:
means for defining a basic service resource capacity between the first LSR and the second LSR; and
means for defining an enhanced service resource capacity between the first LSR and the second LSR.

8. The system of claim 7, wherein the means for routing basic service packet traffic from the first LSR to the second LSR using the first LSP comprises means for routing basic service packet traffic from the first LSR to the second LSR using the first LSP such that the basic service packet traffic does not exceed the basic service resource capacity; and wherein the means for routing enhanced service packet traffic from the first LSR to the second LSR using the second LSP comprises means for routing enhanced service packet traffic from the first LSR to the second LSR using the second LSP such that the enhanced service packet traffic does not exceed the enhanced service resource capacity.

9. The system of claim 7, wherein the basic service resource capacity comprises a basic service bandwidth, and wherein the enhanced service resource capacity comprises an enhanced service bandwidth.

10. The system of claim 9, wherein the means for routing basic service packet traffic from the first LSR to the second LSR using the first LSP comprises means for routing basic service packet traffic from the first LSR to the second LSR using the first LSP such that the basic service packet traffic does not exceed the basic service bandwidth; and wherein the means for routing enhanced service packet traffic from the first LSR to the second LSR using the second LSP comprises means for routing enhanced service packet traffic from the first LSR to the second LSR using the second LSP such that the enhanced service packet traffic does not exceed the enhanced service bandwidth.

11. A computer program product for operating a multiprotocol label switching (MPLS) network, comprising:
a computer readable storage medium having computer readable program code embodied therein, the computer readable program code comprising:
computer readable program code configured to define a first label switched path (LSP) between a first label switched router (LSR) and a second LSR in the MPLS network;
computer readable program code configured to define a second LSP between the first LSR and the second LSR in the MPLS network;
computer readable program code configured to route basic service packet traffic from the first LSR to the second LSR using the first LSP; and
computer readable program code configured to route enhanced service packet traffic from the first LSR to the second LSR using the second LSP.

12. The computer program product of claim 11, further comprising:
computer readable program code configured to define a basic service resource capacity between the first LSR and the second LSR; and
computer readable program code configured to define an enhanced service resource capacity between the first LSR and the second LSR.

13. The computer program product of claim 12, wherein the computer readable program code configured to route basic service packet traffic from the first LSR to the second LSR using the first LSP comprises computer readable program code configured to route basic service packet traffic from the first LSR to the second LSR using the first LSP such that the basic service packet traffic does not exceed the basic service resource capacity; and wherein the computer readable program code configured to route enhanced service packet traffic from the first LSR to the second LSR using the second LSP comprises computer readable program code configured to route enhanced service packet traffic from the first LSR to the second LSR using the second LSP such that the enhanced service packet traffic does not exceed the enhanced service resource capacity.

14. The computer program product of claim 12, wherein the basic service resource capacity comprises a basic service bandwidth, and wherein the enhanced service resource capacity comprises an enhanced service bandwidth.

15. The computer program product of claim 14, wherein the computer readable program code configured to route basic service packet traffic from the first LSR to the second LSR using the first LSP comprises computer readable program code configured to route basic service packet traffic from the first LSR to the second LSR using the first LSP such that the basic service packet traffic does not exceed the basic service bandwidth; and wherein the computer readable program code configured to route enhanced service packet traffic from the first LSR to the second LSR using the second LSP comprises computer readable program code configured to route enhanced service packet traffic from the first LSR to the second LSR using the second LSP such that the enhanced service packet traffic does not exceed the enhanced service bandwidth.
